(19) United States
(12) Patent Application Publication
(10) Pub. No.: US 2026/0093685 A1
(43) Pub. Date: Apr. 2, 2026

(54) DATA PROCESSING METHOD, APPARATUS, AND DEVICE BASED ON COLUMNAR STORAGE DATABASE

(71) Applicant: Beijing Volcano Engine Technology Co., Ltd., Haidian District (CN)

(72) Inventors: Qianling Li, Beijing (CN); Heng Chen, Beijing (CN); Rui Shi, Beijing (CN)

(21) Appl. No.: 19/294,551

(22) Filed: Aug. 8, 2025

(30) Foreign Application Priority Data
Sep. 29, 2024 (CN) 202411378542.2

(51) Int. Cl. G06F 16/23; G06F 16/22

(52) U.S. Cl. CPC G06F 16/2365; G06F 16/221; G06F 16/2237

(57) ABSTRACT

The present application discloses a data processing method and an apparatus based on a columnar storage database and a device, which are used for improving performance of data writing in a scenario where a database has data loss. The method comprises: storing, for a target column in a data table, a line loss identification of the target column by using a bitmap corresponding to the target column, wherein each bit of the bitmap corresponds to whether each line of the target column has data loss, and the target column is any column in the data table; storing actual data included in the target column; receiving a data read request, wherein the data read request includes a column; and establishing, in a memory, a memory structure of the column based on a bitmap corresponding to the column and actual data included in the column.

### CROSS-REFERENCE TO RELATED APPLICATION(S)

The present disclosure claims the priority from the CN patent application No. 202411378542.2 entitled “Data processing method, apparatus, and device based on columnar storage database” filed with the China National Intellectual Property Administration (CNIPA) on Sep. 29, 2024, the contents of which are hereby incorporated by reference in their entirety.

### FIELD

The present application relates to the field of database technologies and, in particular, to a data processing method and an apparatus based on a columnar storage database, and a device.

### BACKGROUND

Based on a columnar storage database, for example, a database of LSM Tree (Log Structured Merge Tree), when writing new data into a data table in the database, one row of data may be directly added to the data table. When data in the data table needs to be modified, one modified row of data is added to the data table. When data is read, for data with the same row number, the latest row of data is returned to achieve the effect that the data has been modified.

### SUMMARY

Embodiments of the present application provide a data processing method and an apparatus based on a columnar storage database and a device.

The technical solutions provided in the embodiments of the present application are as follows:

In a first aspect, an embodiment of the present application provides a data processing method based on a columnar storage database. The method includes:
storing, for a target column in a data table, a line loss identification of the target column by using a bitmap corresponding to the target column, wherein each bit of the bitmap corresponds to whether each line of the target column has data loss, and the target column is any column in the data table;
storing actual data included in the target column;
receiving a data read request, wherein the data read request includes a column; and
establishing, in a memory, a memory structure of the column based on a bitmap corresponding to the column and actual data included in the column, wherein the memory structure includes a loss identification column and a data column, the loss identification column and the data column each include the same number of lines, each line of the loss identification column corresponds to each bit of the bitmap of a corresponding column, and the data column has the actual data included in the corresponding column in a line in which a corresponding line of the loss identification column has no data loss.

In a second aspect, an embodiment of the present application provides a data processing apparatus based on a columnar storage database. The apparatus includes:
a storage unit, configured to store, for a target column in a data table, a line loss identification of the target column by using a bitmap corresponding to the target column, wherein each bit of the bitmap corresponds to whether each line of the target column has data loss, and the target column is any column in the data table;
the storage unit is further configured to store actual data included in the target column;
a receiving unit, configured to receive a data read request, wherein the data read request includes a column; and
an establishing unit, configured to establish, in a memory, a memory structure of the column based on a bitmap corresponding to the column and actual data included in the column, wherein the memory structure includes a loss identification column and a data column, the loss identification column and the data column each include the same number of lines, each line of the loss identification column corresponds to each bit of the bitmap of a corresponding column, and the data column has the actual data included in the corresponding column in a line in which a corresponding line of the loss identification column has no data loss.

In a third aspect, an embodiment of the present application provides a data processing device based on a columnar storage database. The device includes a memory, a processor, and a computer program stored in the memory and executable on the processor. The processor, when executing the computer program, implements the data processing method based on a columnar storage database.

In a fourth aspect, an embodiment of the present application provides a computer-readable storage medium storing instructions. When the instructions are run on a terminal device, the terminal device is enabled to implement the data processing method based on a columnar storage database.

### BRIEF DESCRIPTION OF THE DRAWINGS

FIG. 1 is a schematic diagram of a data read optimization process in a predicate pushdown scenario according to an embodiment of the present application;

FIG. 2 is a flowchart of a data processing method based on a columnar storage database according to an embodiment of the present application;

FIG. 3 is a schematic diagram of a data storage structure according to an embodiment of the present application;

FIG. 4 is a schematic diagram of a memory structure of data according to an embodiment of the present application;

FIG. 5 is a schematic diagram of predicate expression execution according to an embodiment of the present application;

FIG. 6 is a schematic diagram of a predicate expression execution result according to an embodiment of the present application;

FIG. 7 is a schematic diagram of a data processing apparatus based on a columnar storage database according to an embodiment of the present application; and

FIG. 8 is a schematic diagram of an electronic device according to an embodiment of the present application.

### DETAILED DESCRIPTION OF EMBODIMENTS

To make the above objectives, features, and advantages of the embodiments of the present application more comprehensible, the embodiments of the present application are further described in detail below with reference to the drawings and specific implementations.

To facilitate understanding and explanation of the technical solutions provided in the embodiments of the present application, the background of the embodiments of the present application is first described below.

Based on a columnar storage database, for example, a database of LSM Tree (Log Structured Merge Tree), when writing new data into a data table in the database, one row of data may be directly added to the data table. When data in the data table needs to be modified, one modified row of data is added to the data table. When data is read, for data with the same row number, the latest row of data is returned to achieve the effect that the data has been modified.

However, in some scenarios, a complete row of data cannot be written, which may cause data loss in some rows of the data table. Currently, a common solution is that during data writing, if the written data has a missing column, the latest value of the missing column is first read according to the row number to complete the currently written row. However, in this solution, a query and completion process needs to be performed every time one row of data is written, which seriously affects the write performance of the database. Based on a columnar storage database, for example, a database of LSM Tree (Log Structured Merge Tree), when writing new data into a data table in the database, one row of data may be directly added to the data table. When data in the data table needs to be modified, one modified row of data is added to the data table. When data is read, data with the same row number (key) is combined, and usually the latest row of data is used for overwriting the old row data. This strategy is referred to as merge on read (MOR).

In actual application, a service usually has a scenario in which some columns are written, and a complete row of data cannot be written. For example, a data table includes key columns: k1 and k2 and value columns: v1, v2, v3, and v4. Data of the data table comes from different sources. One source writes only the following columns: k1, k2, v1, and v2, and another source writes only the following columns: k1, k2, v3, and v4. In other words, different value columns are provided by different sources, and only some value columns are written each time. In this way, data loss may occur in some rows of the data table.

To ensure line alignment between a plurality of columns, it is necessary to write corresponding line data for each column. Currently, a common solution is that during data writing, if the written data has a missing column, the latest value of the missing column is first read according to the line number to complete the currently written row. A subsequent read process is the same as data that is normally written, and a storage engine does not need to support line data in which some columns are missing. However, in this solution, a query and completion process needs to be performed every time one row of data is written, which seriously affects the write performance of the database.

In addition, during data reading, to improve read efficiency, a filter predicate (such as a conditional expression) also needs to be pushed down to a storage engine for the storage engine to perform read optimization. Common read optimization means that are used by the storage engine include:
1. filtering data by using an index and applying a predicate to the index. For example, a predicate is v1>100 (that is, a value of a v1 column is greater than 100), and an index of the 1st to 100th rows in a data table indicates that a minimum of the v1 column is 1 and a maximum of the v1 column is 80. v1>100 is applied to the index, and it may be learned that the 1st to 100th rows in the data table do not satisfy the filter predicate. Therefore, the 1st to 100th rows may be directly skipped, and data in the 100 rows is not read. For another example, an index of the 100th to 150th rows in the data table indicates that a minimum of the v1 column is 150 and a maximum of the v1 column is 200. In this case, data corresponding to the index satisfies the predicate, and the 100th to 150th rows in the data table may be read.
2. A predicate expression is executed in advance, and target line information is obtained based on an execution result. Then, data of another target column is read. For example, a predicate is v1>100, and a value of a v2 column needs to be read. In this case, a line in which a value of a v1 column is greater than 100 may be determined in a data table, and then a value of the v2 column is read from the line.

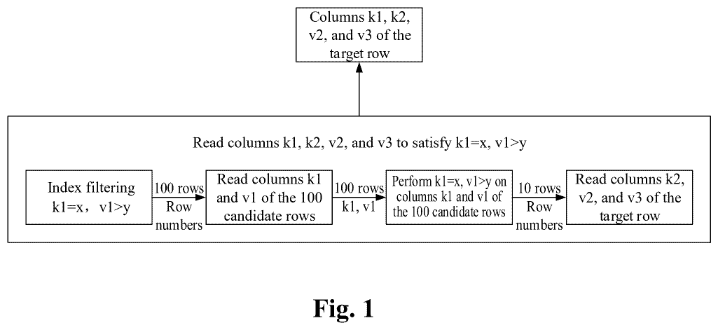

FIG. 1 shows a schematic diagram of a read optimization process performed by a storage engine in a predicate pushdown scenario. For example, according to a data read request, columns that need to be read are k1, k2, v2, and v3 columns, and a predicate is k1=x, v1>y. In other words, object columns corresponding to the predicate are k1 and v1 columns. First, the predicate is applied to an index, to obtain a candidate line number that satisfies the predicate. For example, there are 100 candidate lines in total. Then, according to the candidate line number, the object columns (k1 and v1 columns) corresponding to the predicate are read, and a predicate expression is executed based on column data, to generate a final line number that satisfies the predicate. For example, there are 10 final target lines in total. Other columns (k2, v2, and v3 columns) of the target lines are read, and are aggregated with the read k1 column, to generate a read result. The read result may be delivered to a computing engine for data analysis and processing.

In the case of data loss, to complete the foregoing data read process, the following problems need to be solved: How to perform data storage and reading for a column with a missing line in a data table; what changes need to be made to an index to ensure that when data is filtered by using the index, data is not lost from a filtering result; and how to process information about a missing line of a column when a predicate expression is executed, to ensure that data is not lost from an execution result.

Based on this, the embodiments of the present application provide a data processing method and an apparatus based on a columnar storage database and a device. To solve the technical problem of reduced write performance caused by a query and completion solution during data writing, the storage engine is designed from the perspective of the storage engine, such that the storage engine supports line data in which a column is missing, and supports predicate pushdown and read optimization on the premise that data loss exists.

In view of this, embodiments of the present application provide a data processing method and an apparatus based on a columnar storage database and a device, so as to improve data write performance in the scenario where a database has data loss.

It can be learned that the embodiments of the present application have the following beneficial effects:

In the embodiments of the present application, the bitmap is established for each column in the data table to store the line loss identification of each column, and the actual data of each column is stored at the same time, such that the data table is stored when data loss exists. When data is read, the data is converted from the storage structure to the memory structure. In the memory structure, the data column corresponding to each column in the data table is aligned with the loss identification column, such that data of the corresponding line can be conveniently read according to the line number, and data reading is implemented when data loss occurs. In the embodiments of the present application, because data writing and reading are supported in the scenario where data loss exists, a query and completion process is not required when data is written, and the data write performance is improved.

To facilitate understanding of the embodiments of the present application, the following describes a data processing method based on a columnar storage database according to an embodiment of the present application with reference to the drawings.

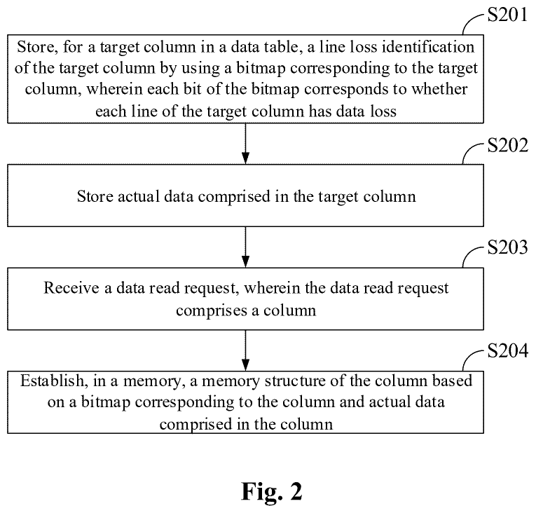

FIG. 2 is a flowchart of a data processing method based on a columnar storage database according to an embodiment of the present application. As shown in FIG. 2, the method may include S201 to S204.

S201: storing, for a target column in a data table, a line loss identification of the target column by using a bitmap corresponding to the target column, wherein each bit of the bitmap corresponds to whether each line of the target column has data loss, and the target column is any column in the data table.

The embodiment of the present application may be applied to a storage engine, and the storage engine may implement operations such as writing and reading data in a database. When the data table is written into the storage engine, a storage structure of the data table needs to be first established. For any column in the data table, the column may be referred to as a target column, and whether a line in the column has data loss is a 0/1 status bit. Therefore, a bitmap structure may be used for storing the line loss identification of each column.

In the embodiments of the present application, each column corresponds to one bitmap, each bit in the bitmap corresponds to one line of the column, and the number of bits in the bitmap is the total number of lines of the column. Each bit in the bitmap is a line loss identification, representing whether the line has data loss. For example, if the line loss identification is 1, it represents that data loss exists; or if the line loss identification is 0, it represents that data loss does not exist.

To improve storage efficiency, the bitmap in the storage structure may be encoded by using encoding means such as RLE (Run-length encoding), to perform lossless data compression storage. An implementation of the bitmap is not limited in the embodiments of the present application.

S202: storing actual data included in the target column.

During data storage for each column, for a missing line, a value of the line does not need to be stored. Therefore, only the actual data included in each column in the data table is stored. For example, in a column, the first line includes a, the second line is missing, and the third line includes b. In this case, the actual data a and b included in the column is stored. The actual data may be various data such as a numerical value or a character string.

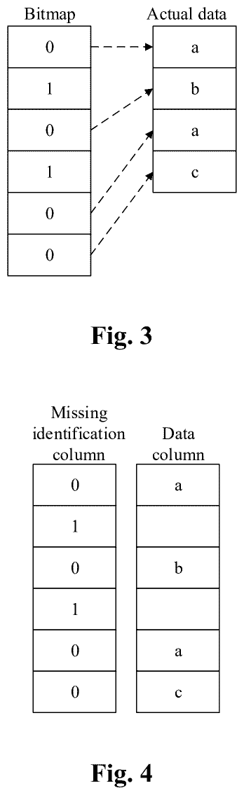

FIG. 3 is a schematic diagram of a data storage structure. For example, a column includes six lines, wherein the second line and the fourth line have data loss. In the storage structure of the column, the bitmap corresponding to the column has six bits, the second bit and the fourth bit are line loss identifications 1, and the other bits are line loss identifications 0. A data column stores actual data a, b, a, and c included in the other four lines of the column. That is, the first line corresponds to the data a, the third line corresponds to the data b, the fifth line corresponds to the data a, and the sixth line corresponds to the data c.

S203: receiving a data read request, wherein the data read request includes a column.

When data needs to be read, the data read request may be received. The data read request includes a column, that is, a column that needs to be read. For example, k1, k2, v2, and v3 columns are columns.

The data read request may further include a predicate, and the predicate is a conditional expression for a specific object column, indicating that the read data needs to satisfy the predicate. For example, the predicate is k1=x, v1>y. In other words, the object columns corresponding to the predicate are k1 and v1 columns. Data in a line that simultaneously satisfies k1=x and v1>y needs to be read from k1, k2, v2, and v3 columns. In the scenario of data loss, how to execute the predicate is described in detail in subsequent embodiments, and is not described in detail here.

S204: establishing, in a memory, a memory structure of the column based on a bitmap corresponding to the column and actual data included in the column, wherein the memory structure includes a loss identification column and a data column, the loss identification column and the data column each include the same number of lines, each line of the loss identification column corresponds to each bit of the bitmap of a corresponding column, and the data column has the actual data included in the corresponding column in a line in which a corresponding line of the loss identification column has no data loss.

When a column is queried and read, data needs to be converted from the storage structure to the memory column structure. The memory structure of the column is established in the memory based on the bitmap corresponding to the column and the actual data included in the column.

In actual application, the corresponding memory structure is a nested column including an outer loss identification column (unset column) and an inner data column. In the nested column, the number of lines in the data column is aligned with the number of lines in the outer loss identification column. Each line of the loss identification column corresponds to each bit of the corresponding bitmap, that is, content included in the loss identification column is consistent with the corresponding bitmap. The data column has the corresponding actual data in a line in which the corresponding loss identification column has no data loss, and has a null value or a specified value representing empty data in another line.

FIG. 4 shows a schematic diagram of a memory structure of data. In this example, the storage structure shown in FIG. 3 is converted into the memory structure. The memory structure includes a loss identification column and a data column. The loss identification column is consistent with the content of the bitmap. The second line and the fourth line have a line loss identification 1, representing that data loss exists, and the other lines have a line loss identification 0, representing that data loss does not exist. The data column and the loss identification column each include six lines. The data column includes the actual data in the lines in which data loss does not exist, that is, the first line includes the data a, the third line includes the data b, the fifth line includes the data a, and the sixth line includes the data c. The second line and the fourth line have a null value or a specified value.

In this way, through the memory structure, data of the corresponding line can be conveniently read directly according to the line number, and the efficiency of data analysis and calculation is improved.

In the embodiments of the present application, the bitmap is established for each column in the data table to store the line loss identification of each column, and the actual data of each column is stored at the same time, such that the data table is stored when data loss exists. When data is read, the data is converted from the storage structure to the memory structure. In the memory structure, the data column corresponding to each column in the data table is aligned with the loss identification column, such that data of the corresponding line can be conveniently read according to the line number, and data reading is implemented when data loss occurs. In the embodiments of the present application, because data writing and reading are supported in the scenario where data loss exists, a query and completion process is not required when data is written, and the data write performance is improved.

For a column in a data table, if there is missing line data, a predicate cannot be determined. Therefore, a predicate execution result should be true, that is, a predicate condition is satisfied. For an on-column index that exists in the data table, when the predicate is applied to the index, such logic also needs to be followed. In the embodiments of the present application, a processing manner of the index in the data table is provided in the case where the data table has data loss.

For a maximum-minimum index, in a possible implementation, the data processing method based on a columnar storage database provided in the embodiments of the present application may further include the following steps.
A1: reading a maximum-minimum index of a first object column in a data table.

If a certain column in the data table has the maximum-minimum index, the column is the first object column, and the maximum-minimum index is read. The maximum-minimum index records a maximum and a minimum in a specific range of lines in the first object column. For example, it can be learned, through the maximum-minimum index, that a maximum of a v1 column in a range of the 10th line to the 100th line is 100, and a minimum of the v1 column is 10.
A2: reading a first line number range in a bitmap corresponding to the first object column, wherein the first line number range is a line number range corresponding to the maximum-minimum index.

The line number range corresponding to the maximum-minimum index is the first line number range. Content in the first line number range is read from the bitmap corresponding to the first object column, to learn whether each line in the first line number range has data loss.
A3: in response to data loss existing in the first line number range, marking the maximum-minimum index as invalid, such that the first line number range in the data table is not filtered when the maximum-minimum index is applied.

In response to data loss existing in the first line number range, the maximum and the minimum of the first object column in the first line number range actually cannot be determined. Therefore, the maximum-minimum index needs to be marked as invalid. When any predicate is applied to the maximum-minimum index, it is necessary to return an execution result of true, that is, the index cannot determine the predicate as false, and the first line number range in the data table is not filtered. The line number in the first line number range needs to be retained as the candidate line number.

Based on this, in a possible implementation, the data processing method based on a columnar storage database provided in the embodiments of the present application may further include the following step.

In response to the data read request further including a predicate, and the predicate being a conditional expression of the first object column, when the predicate is applied to the maximum-minimum index, determining that the maximum-minimum index satisfies the predicate, and outputting all line numbers in the first line number range as candidate line numbers.

In other words, in response to the data read request further including the predicate, the predicate is the conditional expression of the first object column. For example, the predicate is v1>120. When the predicate is applied to the maximum-minimum index, because the maximum-minimum index has been marked as invalid, it is determined that the maximum-minimum index satisfies the predicate, and all line numbers in the first line number range are output as the candidate line numbers. For example, the maximum-minimum index indicates that a maximum of a v1 column in a range of the 10th line to the 100th line is 100, and a minimum of the v1 column is 10. Because the v1 column has data loss, the 10th line to the 100th line cannot be skipped through the predicate v1>120. Therefore, the maximum-minimum index is marked as invalid, and the 10th line to the 100th line are output as the candidate line numbers.

In the embodiments of the present application, when data loss exists in the data table, the maximum-minimum index is adjusted accordingly, and the adjusted maximum-minimum index can be correctly applied when data is read.

For a Bloom filter index, in a possible implementation, the data processing method based on a columnar storage database provided in the embodiments of the present application may further include the following steps.

B1: reading a Bloom filter index of a second object column in a data table.

If a specific column in the data table has a Bloom filter index, the column is the second object column, and the Bloom filter index is read. The Bloom filter index is to construct a Bloom filter for values that appear in a specific range of lines in the second object column. For a value that has not appeared, when the Bloom filter is queried, an execution result of false is returned with high probability; or for a value that has appeared, when the Bloom filter is queried, an execution result of true is returned for sure.

B2: reading a second line number range in a bitmap corresponding to the second object column, wherein the second line number range is a line number range corresponding to the Bloom filter index.

The line number range corresponding to the Bloom filter index is the second line number range. Content in the second line number range is read from the bitmap corresponding to the second object column, to learn whether each line in the second line number range has data loss.

B3: in response to data loss existing in the second line number range, marking the Bloom filter index as invalid, such that the second line number range in the data table is not filtered when the Bloom filter index is applied.

Similar to the maximum-minimum index, in response to data loss existing in the second line number range, the Bloom filter index needs to be marked as invalid. When any predicate is applied to the Bloom filter, it is necessary to return an execution result of true, that is, the index cannot determine the predicate as false, and the second line number range in the data table is not filtered. The line number in the second line number range needs to be retained as the candidate line number.

Based on this, in a possible implementation, the data processing method based on a columnar storage database provided in the embodiments of the present application may further include the following step.

In response to the data read request further including a predicate, and the predicate being a conditional expression of the second object column, when the predicate is applied to the Bloom filter index, determining that the Bloom filter index satisfies the predicate, and outputting all line numbers in the second line number range as candidate line numbers.

In other words, in response to the data read request further including the predicate, the predicate is the conditional expression of the second object column. When the predicate is applied to the Bloom filter index, because the Bloom filter index has been marked as invalid, it is determined that the Bloom filter index satisfies the predicate, and all line numbers in the second line number range are output as the candidate line numbers.

In the embodiments of the present application, when data loss exists in the data table, the Bloom filter index is adjusted accordingly, and the adjusted Bloom filter index can be correctly applied when data is read.

For an inverted index, in a possible implementation, the data processing method based on a columnar storage database provided in the embodiments of the present application may further include the following step.

C1: reading an inverted index of a third object column in a data table.

If a specific column in the data table has an inverted index, the column is the third object column, and the inverted index is read. The inverted index is to establish an inverted mapping between values that appear in a specific range and line numbers at which the values appear in the third object column. For example, in the example in FIG. 3 and FIG. 4, three values a, b, and c appear. The inverted index needs to maintain mapping between the three values and the line numbers, and establish inverted chains: a->1, 5, b->3, and c->6.

C2: reading a third line number range in a bitmap corresponding to the third object column, wherein the third line number range is a line number range corresponding to the inverted index.

The line number range corresponding to the inverted index is the third line number range. Content in the third line number range is read from the bitmap corresponding to the third object column, to learn whether each line in the third line number range has data loss.

C3: establishing a missing value inverted chain based on line numbers with data loss in the third line number range, and adding the missing value inverted chain into the inverted index.

If there is data loss in the third line number range, the line numbers with data loss needs to be established as the missing value inverted chain, and the missing value inverted chain is added to the inverted index. For example, based on the foregoing example, the missing value inverted chain: missing value->2, 4 needs to be further added to the inverted index.

Based on this, in a possible implementation, the data processing method based on a columnar storage database provided in the embodiments of the present application may further include the following step.

In response to the data read request further including a predicate, and the predicate being a conditional expression of the third object column, when the predicate is applied to the inverted index, determining a line number in an inverted chain that satisfies the predicate and a line number in the missing value inverted chain as candidate line numbers.

When data loss does not exist, the predicate is applied to the index. For example, when the third object column=a, the inverted chain a->1, 5 that satisfies the predicate may be read, to obtain the line numbers 1 and 5 as the candidate line numbers. However, when data loss exists, this cannot be directly performed. The line number of the line with data loss also needs to be used as the candidate line number range. Therefore, the missing value inverted chain also needs to be read. For example, when the predicate that the third object column=a is applied, the two inverted chains a->1, 5 and missing value->2, 4 need to be combined, to obtain 1, 2, 4, and 5 as the candidate line numbers.

In the embodiments of the present application, when data loss exists in the data table, the inverted index is adjusted accordingly, and the adjusted inverted index can be correctly applied when data is read.

In addition, in the embodiments of the present application, a predicate expression execution process is further provided based on the memory structure in the scenario of data loss.

A first solution for supporting predicate expression execution in the case of a missing line is described below. In a possible implementation, the data processing method based on a columnar storage database provided in the embodiments of the present application may further include the following steps.

D1: in response to the data read request further including a predicate, and the predicate being a conditional expression of a fourth object column, establishing, based on a bitmap corresponding to the fourth object column and actual data included in the fourth object column, a memory structure of the fourth object column.

In response to the data read request further including the predicate, the predicate is the conditional expression of the fourth object column. The fourth object column may be a column. In this case, the memory structure of the fourth object column may be obtained. When the fourth object column is not the column, the storage structure of the fourth object column may be converted into the memory structure. Similarly, the memory structure of the fourth object column includes a loss identification column and a data column.

D2: determining a target line number in which the actual data included in a target data column satisfies the predicate, and determining a line number in which the target loss identification column has data loss as a target line number that satisfies the predicate, wherein the target data column is a data column in the memory structure of the fourth object column, and the target loss identification column is a loss identification column in the memory structure of the fourth object column.

The predicate is executed for the data column in the memory structure of the fourth object column, to obtain a line number in which the data column (that is, the target data column) satisfies the predicate, as the target line number. If the fourth object column has an index, the fourth object column is the first object column, the second object column, or the third object column, and the line number that satisfies the predicate may be determined from the candidate line number. If the fourth object column does not have an index, the line number that satisfies the predicate is determined from all line numbers. In addition, the line number in which the target loss identification column has data loss is determined as the target line number that satisfies the predicate. The two constitute the output target line number together.

In other words, each predicate condition expression execution operator supports the memory structure of the nested column. When executing the operator, if it is found that the missing identification value of a line is 1, the operator sets an execution result of the operator on the line to true. That is, F(unset<A>)=is_unset(unset<>) OR F(A).

D3: obtaining, from the memory structure of the column, data of the data column of the column in the target line number.

Finally, the actual data in the target line number is read from the memory structure of the column.

However, this solution greatly undermines the execution engine. Each predicate condition expression execution operator needs to support this solution, and the missing identification value needs to be checked in the calculation process of each predicate, which affects the execution efficiency. Therefore, the embodiments of the present application further provide a second solution for supporting predicate expression execution in the case of a missing line.

A second solution for supporting predicate expression execution in the case of a missing line is described below. In a possible implementation, the data processing method based on a columnar storage database provided in the embodiments of the present application may further include the following steps.

E1: in response to the data read request further including a predicate, and the predicate being a conditional expression of a fourth object column, establishing, based on a bitmap corresponding to the fourth object column and actual data included in the fourth object column, a memory structure of the fourth object column.

In response to the data read request further including the predicate, the predicate is the conditional expression of the fourth object column. The fourth object column may be a column. In this case, the memory structure of the fourth object column may be obtained. When the fourth object column is not the column, the storage structure of the fourth object column may be converted into the memory structure. Similarly, the memory structure of the fourth object column includes a loss identification column and a data column.

E2: writing a default value into a target data column for a line in which a target loss identification column has data loss, wherein the target data column is a data column in the memory structure of the fourth object column, and the target loss identification column is a loss identification column in the memory structure of the fourth object column.

For the fourth object column, the loss identification column in the memory structure is the target loss identification column, and the data column in the memory structure is the target data column. First, the target loss identification column needs to be stripped, and only the target data column is retained. That is, for a line in which the target loss identification column has data loss, a default value is written into a corresponding line in the target data column, for example, 0. The default value may be set according to an actual situation, and the default value is not limited in the embodiments of the present application.

E3: determining a target line number in which the actual data included in the target data column satisfies the predicate, and determining a line number in which the target data column has the default value as a target line number that satisfies the predicate.

The predicate is executed for the updated data column, to obtain a line number in which the target data column satisfies the predicate, as the target line number. If the fourth object column has an index, the fourth object column is the first object column, the second object column, or the third object column, and the line number that satisfies the predicate may be determined from the candidate line number. If the fourth object column does not have an index, the line number that satisfies the predicate is determined from all line numbers. In addition, the line number in which the target data column has the default value is determined as the target line number that satisfies the predicate. The two constitute the output target line number together.

E4: modifying the default value in the target data column to data loss.

If the fourth object column is the column, the default value in the target data column needs to be modified to data loss, for example, a null value or a specified value representing empty data, to restore the original memory structure.

E5: obtaining, from the memory structure of the column, data of the data column of the column in the target line number.

Finally, the actual data in the target line number is read from the memory structure of the column.

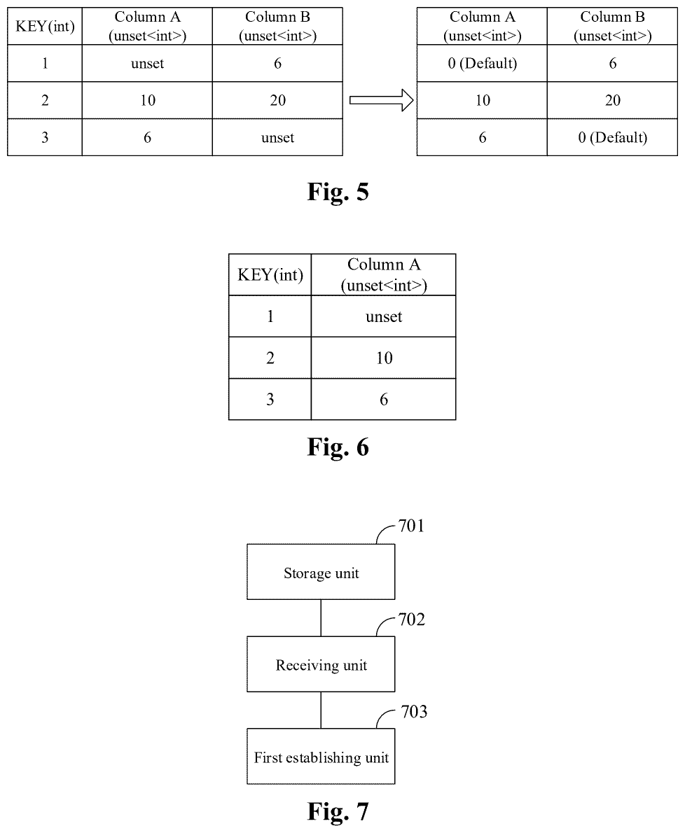

FIG. 5 shows a schematic diagram of predicate expression execution in this embodiment. For example, the predicate is A>0 and B>0, that is, column A>0 and column B>0. Column A and column B are the fourth object columns, and the column is column A. Data of column A and column B is shown on the left of FIG. 5, wherein unset is a specified value representing empty data in the data column. After the data missing column is stripped, as shown on the right of FIG. 5, the specified value in the data column is written with the default value 0. An execution result of the predicate expression corresponding to each row is (false, true, false). Because the default value appears in the first row (in column A) and the third row (in column B), the execution result is rewritten to (true, true, true), and the output target line numbers are 1, 2, and 3.

FIG. 6 shows a schematic diagram of a predicate expression execution result in this embodiment. Continuing with the foregoing example, column A is used as the column, and unset information needs to be added back. That is, the default value in the data column of column A is modified to unset, and an output result of the final execution engine is shown in FIG. 6.

In this embodiment, it is only necessary to process the data column before the predicate expression is executed, to change the data column to column data recognizable by a normal expression. After the execution, the execution result is rewritten based on the unset information. The entire process does not require the predicate expression execution engine to recognize the unset information. In addition, data leakage filtering and multi-recall may occur in this simplified processing method. For example, based on the foregoing example, the predicate expression is modified to A>0 and B>10. Although the first row and the third row have the unset information, the predicate condition is not satisfied. According to this solution, the two rows are still considered as possibly satisfying the predicate, and the two rows are returned as the execution result. This simplified processing process and the data processing manner in which more data is returned are usually allowed in the predicate pushdown scenario of the actual data column, and do not affect the correctness of a subsequent processing result.

Based on the data processing method based on a columnar storage database provided in the foregoing method embodiments, an embodiment of the present application further provides a data processing apparatus based on a columnar storage database. The apparatus is described below with reference to the drawings.

FIG. 7 is a schematic diagram of a structure of a data processing apparatus based on a columnar storage database according to an embodiment of the present application. As shown in FIG. 7, the data processing apparatus based on a columnar storage database includes a storage unit 701, a receiving unit 702, and an establishing unit 703.

The storage unit 701 is configured to: store, for a target column in a data table, a line loss identification of the target column by using a bitmap corresponding to the target column, wherein each bit of the bitmap corresponds to whether each line of the target column has data loss, and the target column is any column in the data table.

The storage unit 701 is further configured to store actual data included in the target column.

The receiving unit 702 is configured to receive a data read request, wherein the data read request includes a column.

The establishing unit 703 is configured to establish, in a memory, a memory structure of the column based on a bitmap corresponding to the column and actual data included in the column, wherein the memory structure includes a loss identification column and a data column, the loss identification column and the data column each include the same number of lines, each line of the loss identification column corresponds to each bit of the bitmap of a corresponding column, and the data column has the actual data included in corresponding column in a line in which a corresponding line of the loss identification column has no data loss.

In a possible implementation, the apparatus further includes:
a first reading unit, configured to read a maximum-minimum index of a first object column in the data table;
a second reading unit, configured to read a first line number range in a bitmap corresponding to the first object column, wherein the first line number range is a line number range corresponding to the maximum-minimum index; and
a first marking unit, configured to: in response to data loss existing in the first line number range, mark the maximum-minimum index as invalid, such that the first line number range in the data table is not filtered when the maximum-minimum index is applied.

In a possible implementation, the apparatus further includes:
a third reading unit, configured to read a Bloom filter index of a second object column in the data table;
a fourth reading unit, configured to read a second line number range in a bitmap corresponding to the second object column, wherein the second line number range is a line number range corresponding to the Bloom filter index; and
a second marking unit, configured to: in response to data loss existing in the second line number range, mark the Bloom filter index as invalid, such that the second line number range in the data table is not filtered when the Bloom filter index is applied.

In a possible implementation, the apparatus further includes:
a fifth reading unit, configured to read an inverted index of a third object column in the data table;
a sixth reading unit, configured to read a third line number range in a bitmap corresponding to the third object column, wherein the third line number range is a line number range corresponding to the inverted index; and
an adding unit, configured to: establish a missing value inverted chain based on line numbers with data loss in the third line number range, and add the missing value inverted chain into the inverted index.

In a possible implementation, the apparatus further includes:
a first determining unit, configured to: in response to the data read request further including a predicate, and the predicate being a conditional expression of the first object column, when the predicate is applied to the maximum-minimum index, determine that the maximum-minimum index satisfies the predicate, and output all line numbers in the first line number range as candidate line numbers.

In a possible implementation, the apparatus further includes:
a second determining unit, configured to: in response to the data read request further including a predicate, and the predicate being a conditional expression of the second object column, when the predicate is applied to the bloom filter index, determine that the bloom filter index satisfies the predicate, and output all line numbers in the second line number range as candidate line numbers.

In a possible implementation, the apparatus further includes:
a third determining unit, configured to: in response to the data read request further including a predicate, and the predicate being a conditional expression of the third object column, when the predicate is applied to the inverted index, determine a line number in an inverted chain that satisfies the predicate and a line number in the missing value inverted chain as candidate line numbers.

In a possible implementation, the apparatus further includes:
a second establishing unit, configured to: in response to the data read request further including a predicate, and the predicate being a conditional expression of a fourth object column, establish, based on a bitmap corresponding to the fourth object column and actual data included in the fourth object column, a memory structure of the fourth object column;
a fourth determining unit, configured to: determine a target line number in which the actual data included in a target data column satisfies the predicate, and determine a line number in which a target loss identification column has data loss as a target line number that satisfies the predicate, wherein the target data column is a data column in the memory structure of the fourth object column, and the target loss identification column is a loss identification column in the memory structure of the fourth object column; and
a first obtaining unit, configured to obtain, from the memory structure of the column, data of the data column of the column in the target line number.

In a possible implementation, the apparatus further includes:
a third establishing unit, configured to: in response to the data read request further including a predicate, and the predicate being a conditional expression of a fourth object column, establish, based on a bitmap corresponding to the fourth object column and actual data included in the fourth object column, a memory structure of the fourth object column;
a writing unit, configured to write a default value into a target data column for a line in which a target loss identification column has data loss, wherein the target data column is a data column in the memory structure of the fourth object column, and the target loss identification column is a loss identification column in the memory structure of the fourth object column;
a fifth determining unit, configured to: determine a target line number in which the actual data included in the target data column satisfies the predicate, and determine a line number in which the target data column has the default value as a target line number that satisfies the predicate;
a modifying unit, configured to modify the default value in the target data column to data loss; and
a second obtaining unit, configured to obtain, from the memory structure of the column, data of the data column of the column in the target line number.

In addition, the embodiments of the present application further provide a computer program product. The computer program product includes a computer program instruction. When the computer program instruction is run on a computer, the computer is enabled to perform the data processing method based on a columnar storage database according to any one of the above.

Based on the data processing method based on a columnar storage database provided in the foregoing method embodiments, the present application further provides an electronic device. The electronic device includes one or more processors and a storage apparatus. The storage apparatus stores one or more programs, and the one or more programs, when executed by the one or more processors, cause the one or more processors to implement the data processing method based on a columnar storage database according to any one of the above embodiments.

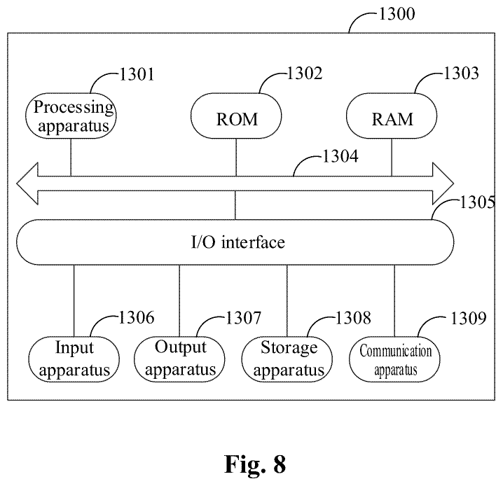

Reference is made to FIG. 8 below, which shows a schematic diagram of a structure of an electronic device 1300 according to an embodiment of the present application. The terminal device in this embodiment of the present application may include, but is not limited to, a mobile terminal such as a mobile phone, a notebook computer, a digital broadcast receiver, a personal digital assistant (PDA), a tablet computer, a portable media player (PMP), and a vehicle-mounted terminal (such as a vehicle-mounted navigation terminal), and a stationary terminal such as a digital television (TV) and a desktop computer. The electronic device shown in FIG. 8 is merely an example, and should not impose any limitation on the function and scope of use of this embodiment of the present application.

As shown in FIG. 8, the electronic device 1300 may include a processing apparatus 1301 (such as a central processing unit or a graphics processing unit). The processing apparatus 1301 may perform various appropriate actions and processing based on a program stored in a read-only memory (ROM) 1302 or a program loaded from a storage apparatus 1306 into a random access memory (RAM) 1303. The RAM 1303 further stores various programs and data required for the operation of the electronic device 1300. The processing apparatus 1301, the ROM 1302, and the RAM 1303 are connected to each other through a bus 1304. An input/output (I/O) interface 1305 is also connected to the bus 1304.

Usually, the following apparatus may be connected to the I/O interface 1305: an input apparatus 1306, including, for example, a touchscreen, a touchpad, a keyboard, a mouse, a camera, a microphone, an accelerometer, and a gyroscope; an output apparatus 1307, including, for example, a liquid crystal display (LCD), a speaker, and a vibrator; a storage apparatus 1306, including, for example, a magnetic tape and a hard disk; and a communication apparatus 1309. The communication apparatus 1309 may allow the electronic device 1300 to perform wireless or wired communication with another device to exchange data. Although FIG. 8 shows the electronic device 1300 having various apparatus, it should be understood that not all the apparatus shown here need to be implemented or provided. Alternatively, more or fewer apparatus may be implemented or provided.

In particular, according to the embodiments of the present application, the process described above with reference to the flowchart may be implemented as a computer software program. For example, an embodiment of the present application includes a computer program product. The computer program product includes a computer program carried on a non-transitory computer-readable medium. The computer program includes program code for performing the method shown in the flowchart. In such an embodiment, the computer program may be downloaded from a network through the communication apparatus 1309 and installed, or may be installed from the storage apparatus 1306, or may be installed from the ROM 1302. When the computer program is executed by the processing apparatus 1301, the above functions defined in the methods of the embodiments of the present application are performed.

The electronic device provided in this embodiment of the present application and the data processing method based on a columnar storage database provided in the foregoing embodiment belong to the same inventive concept. For the technical details not described in detail in this embodiment, reference may be made to the foregoing embodiments. This embodiment and the foregoing embodiments have the same beneficial effects.

Based on the data processing method based on a columnar storage database provided in the foregoing method embodiments, an embodiment of the present application provides a computer-readable medium. The computer-readable medium stores a computer program, and the computer program, when executed by a processor, implements the data processing method based on a columnar storage database according to any one of the above embodiments.

It should be noted that the computer-readable medium in the embodiments of the present application may be a computer-readable signal medium or a computer-readable storage medium or any combination thereof. The computer-readable storage medium may be, for example, but not limited to, an electrical, magnetic, optical, electromagnetic, infrared, or semiconductor system, apparatus, or device or any combination thereof. More specific examples of the computer-readable storage medium may include, but are not limited to, an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the embodiments of the present application, the computer-readable storage medium may be any tangible medium that includes or stores a program. The program may be used by or used in conjunction with an instruction execution system, apparatus, or device. In the embodiments of the present application, the computer-readable signal medium may include a data signal propagated in baseband or as a part of a carrier wave, and computer-readable program code is carried in the data signal. The data signal propagated in this manner may be in multiple forms and includes, but is not limited to, an electromagnetic signal, an optical signal, or any suitable combination thereof. The computer-readable signal medium may also be any computer-readable medium other than the computer-readable storage medium. The computer-readable signal medium may send, propagate, or transmit a program used by or used in conjunction with an instruction execution system, apparatus, or device. The program code included on the computer-readable medium may be transmitted by using any suitable medium, including, but not limited to, a wire, an optical cable, radio frequency (RF), or any suitable combination thereof.

In some implementations, the client and the server may communicate using any currently known or future developed network protocol such as the Hypertext transfer protocol (HTTP), and may be interconnected with any form or medium of digital data communication (for example, a communication network). Examples of the communication network include a local area network (“LAN”), a wide area network (“WAN”), an internet (for example, the Internet), and a peer-to-peer network (for example, an ad hoc network), and any currently known or future developed network.

The computer-readable medium may be included in the electronic device, or may exist alone without being assembled into the electronic device.

The computer-readable medium carries one or more programs, and the electronic device is enabled to perform the data processing method based on a columnar storage database when the one or more programs are executed by the electronic device.

The computer program code for performing the operations in the embodiments of the present application may be written in one or more programming languages or a combination thereof. The foregoing programming languages include object-oriented programming languages such as Java, Smalltalk, and C++, and conventional procedural programming languages such as the C programming language or similar programming languages. The program code may be executed entirely on a computer of a user, executed partly on a computer of a user, executed as a stand-alone software package, executed partly on a computer of a user and partly on a remote computer, or executed entirely on a remote computer or a server. In the scenario related to the remote computer, the remote computer may be connected to the computer of the user through any type of network, including a local area network (LAN) or a wide area network (WAN), or the connection may be made to an external computer (for example, through the Internet using an Internet service provider).

The flowcharts and block diagrams in the drawings show possible system architectures, functions, and operations of the system, method, and computer program product according to the embodiments of the present application. In this regard, each block in the flowcharts or block diagrams may represent a module, a program segment, or part of code. The module, program segment, or part of code includes one or more executable instructions for implementing specified logical functions. It is also to be noted that, in some alternative implementations, the functions indicated in the blocks may be implemented in an order different from those indicated in the drawings. For example, two blocks shown in succession may, in fact, be performed substantially concurrently, or the two blocks may sometimes be performed in a reverse order, depending on the functions involved. It is also to be noted that each block in the block diagrams and/or flowcharts and a combination of blocks in the block diagrams and/or flowcharts may be implemented by a dedicated hardware-based system that performs specified functions or operations, or may be implemented by a combination of dedicated hardware and computer instructions.

The units involved in the embodiments of the present application may be implemented by software or hardware. The name of a unit/module does not constitute a limitation on the unit itself under certain circumstances.

The functions described herein may be performed, at least in part, by one or more hardware logic components. For example, and without limitation, illustrative types of hardware logic components that may be used include: a field programmable gate array (FPGA), an application specific integrated circuit (ASIC), an application specific standard product (ASSP), a system on chip (SOC), a complex programmable logic device (CPLD), and the like.

In the context of the embodiments of the present application, a machine-readable medium may be a tangible medium that may include or store a program for use by or in conjunction with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific examples of the machine-readable storage medium may include an electrical connection having one or more wires, a portable computer disk, a hard disk, a random access memory (RAM), a read only memory (ROM), an erasable programmable read only memory (EPROM or flash memory), an optical fiber, a portable compact disc read only memory (CD-ROM), an optical storage device, a magnetic storage device, or any suitable combination of the foregoing.

It should be noted that the embodiments of the present application are described in a progressive manner, and focus of each embodiment is on the difference from other embodiments, and the same or similar parts between the embodiments may be referred to each other. For the system or apparatus disclosed in the embodiments, since it corresponds to the method disclosed in the embodiments, the description is relatively simple, and reference may be made to the method part for related parts.

It should be understood that in the present application, “at least one” means one or more, and “a plurality of” means two or more. “And/or” is used for describing an association relationship between associated objects, and represents that three relationships may exist. For example, “A and/or B” may represent the following three cases: only A exists, only B exists, and both A and B exist, wherein A and B may be singular or plural. The character “/” generally indicates that the associated objects before and after the character are in an “or” relationship. “At least one of the following” or similar expressions refer to any combination of these items, including any combination of a single item (one item) or a plurality of items (a plurality of items). For example, at least one of a, b, or c may represent: a, b, c, “a and b”, “a and c”, “b and c”, or “a and b and c”, wherein a, b, and c may be singular or plural.

It should be further noted that in the present specification, relational terms such as first and second are merely used for distinguishing one entity or operation from another entity or operation, and do not necessarily require or imply any such actual relationship or order between these entities or operations. Moreover, the term “include/comprise” or any other variation thereof is intended to cover a non-exclusive inclusion, such that a process, method, article, or device that includes a list of elements not only includes those elements but also includes other elements that are not expressly listed or that are inherent to such a process, method, article, or device. Without more limitations, an element defined by a statement “include/comprise one . . . . ” does not exclude the presence of another same element in a process, method, article, or device that includes the element.

Steps of the methods or algorithms described in connection with the embodiments disclosed herein may be implemented directly in hardware, a software module executed by a processor, or a combination thereof. The software module may reside in a random access memory (RAM), a memory, a read-only memory (ROM), an electrically programmable ROM, an electrically erasable programmable ROM, a register, a hard disk, a removable magnetic disk, a CD-ROM, or any other form of storage medium known in the art.

The above description of the disclosed embodiments enables those skilled in the art to implement or use the present application. Various modifications to these embodiments will be readily apparent to those skilled in the art, and the generic principles defined herein may be implemented in other embodiments without departing from the spirit or scope of the present application. Therefore, the present application is not limited to these embodiments shown herein, but is to be accorded the widest scope consistent with the principles and novel features disclosed herein.

I/We claim:

1. A data processing method based on a columnar storage database, comprising:
storing, for a target column in a data table, a line loss identification of the target column by using a bitmap corresponding to the target column, wherein each bit of the bitmap corresponds to whether each line of the target column has data loss, and the target column is any column in the data table;
storing actual data comprised in the target column;
receiving a data read request, wherein the data read request comprises a column; and
establishing, in a memory, a memory structure of the column based on a bitmap corresponding to the column and actual data comprised in the column, wherein the memory structure comprises a loss identification column and a data column, the loss identification column and the data column each comprise the same number of lines, each line of the loss identification column corresponds to each bit of the bitmap of a corresponding column, and the data column has the actual data comprised in the corresponding column in a line in which a corresponding line of the loss identification column has no data loss.

2. The method according to claim 1, wherein the method further comprises:
reading a maximum-minimum index of a first object column in the data table;
reading a first line number range in a bitmap corresponding to the first object column, wherein the first line number range is a line number range corresponding to the maximum-minimum index; and
in response to data loss existing in the first line number range, marking the maximum-minimum index as invalid, such that the first line number range in the data table is not filtered when the maximum-minimum index is applied.

3. The method according to claim 1, wherein the method further comprises:
reading a Bloom filter index of a second object column in the data table;
reading a second line number range in a bitmap corresponding to the second object column, wherein the second line number range is a line number range corresponding to the Bloom filter index; and
in response to data loss existing in the second line number range, marking the Bloom filter index as invalid, such that the second line number range in the data table is not filtered when the Bloom filter index is applied.

4. The method according to claim 1, wherein the method further comprises:
reading an inverted index of a third object column in the data table;
reading a third line number range in a bitmap corresponding to the third object column, wherein the third line number range is a line number range corresponding to the inverted index; and
establishing a missing value inverted chain based on line numbers with data loss in the third line number range, and adding the missing value inverted chain into the inverted index.

5. The method according to claim 2, wherein the method further comprises:
in response to the data read request further comprising a predicate, and the predicate being a conditional expression of the first object column, when the predicate is applied to the maximum-minimum index, determining that the maximum-minimum index satisfies the predicate, and outputting all line numbers in the first line number range as candidate line numbers.

6. The method according to claim 3, wherein the method further comprises:
in response to the data read request further comprising a predicate, and the predicate being a conditional expression of the second object column, when the predicate is applied to the bloom filter index, determining that the bloom filter index satisfies the predicate, and outputting all line numbers in the second line number range as candidate line numbers.

7. The method according to claim 4, wherein the method further comprises:
in response to the data read request further comprising a predicate, and the predicate being a conditional expression of the third object column, when the predicate is applied to the inverted index, determining a line number in an inverted chain that satisfies the predicate and a line number in the missing value inverted chain as candidate line numbers.

8. The method according to claim 1, wherein the method further comprises:
in response to the data read request further comprising a predicate, and the predicate being a conditional expression of a fourth object column, establishing, based on a bitmap corresponding to the fourth object column and actual data comprised in the fourth object column, a memory structure of the fourth object column;
determining a target line number in which the actual data comprised in a target data column satisfies the predicate, and determining a line number in which a target loss identification column has data loss as a target line number that satisfies the predicate, wherein the target data column is a data column in the memory structure of the fourth object column, and the target loss identification column is a loss identification column in the memory structure of the fourth object column; and
obtaining, from the memory structure of the column, data of the data column of the column in the target line number.

9. The method according to claim 1, wherein the method further comprises:
in response to the data read request further comprising a predicate, and the predicate being a conditional expression of a fourth object column, establishing, based on a bitmap corresponding to the fourth object column and actual data comprised in the fourth object column, a memory structure of the fourth object column;
writing a default value into a target data column for a line in which a target loss identification column has data loss, wherein the target data column is a data column in the memory structure of the fourth object column, and the target loss identification column is a loss identification column in the memory structure of the fourth object column;
determining a target line number in which the actual data comprised in the target data column satisfies the predicate, and determining a line number in which the target data column has the default value as a target line number that satisfies the predicate;
modifying the default value in the target data column to data loss; and
obtaining, from the memory structure of the column, data of the data column of the column in the target line number.

10. A data processing device based on a columnar storage database, comprising: a memory, a processor, and a computer program stored in the memory and executable by the processor, wherein the processor, when executing the computer program, implements a data processing method based on a columnar storage database comprising:
storing, for a target column in a data table, a line loss identification of the target column by using a bitmap corresponding to the target column, wherein each bit of the bitmap corresponds to whether each line of the target column has data loss, and the target column is any column in the data table;
storing actual data comprised in the target column;
receiving a data read request, wherein the data read request comprises a column; and
establishing, in a memory, a memory structure of the column based on a bitmap corresponding to the column and actual data comprised in the column, wherein the memory structure comprises a loss identification column and a data column, the loss identification column and the data column each comprise the same number of lines, each line of the loss identification column corresponds to each bit of the bitmap of a corresponding column, and the data column has the actual data comprised in the corresponding column in a line in which a corresponding line of the loss identification column has no data loss.

11. The data processing device according to claim 10, wherein the method further comprises:
reading a maximum-minimum index of a first object column in the data table;
reading a first line number range in a bitmap corresponding to the first object column, wherein the first line number range is a line number range corresponding to the maximum-minimum index; and
in response to data loss existing in the first line number range, marking the maximum-minimum index as invalid, such that the first line number range in the data table is not filtered when the maximum-minimum index is applied.

12. The data processing device according to claim 10, wherein the method further comprises:
reading a Bloom filter index of a second object column in the data table;
reading a second line number range in a bitmap corresponding to the second object column, wherein the second line number range is a line number range corresponding to the Bloom filter index; and
in response to data loss existing in the second line number range, marking the Bloom filter index as invalid, such that the second line number range in the data table is not filtered when the Bloom filter index is applied.

13. The data processing device according to claim 10, wherein the method further comprises:
reading an inverted index of a third object column in the data table;
reading a third line number range in a bitmap corresponding to the third object column, wherein the third line number range is a line number range corresponding to the inverted index; and
establishing a missing value inverted chain based on line numbers with data loss in the third line number range, and adding the missing value inverted chain into the inverted index.

14. The data processing device according to claim 11, wherein the method further comprises:
in response to the data read request further comprising a predicate, and the predicate being a conditional expression of the first object column, when the predicate is applied to the maximum-minimum index, determining that the maximum-minimum index satisfies the predicate, and outputting all line numbers in the first line number range as candidate line numbers.

15. The data processing device according to claim 12, wherein the method further comprises:
in response to the data read request further comprising a predicate, and the predicate being a conditional expression of the second object column, when the predicate is applied to the bloom filter index, determining that the bloom filter index satisfies the predicate, and outputting all line numbers in the second line number range as candidate line numbers.

16. The data processing device according to claim 13, wherein the method further comprises:
in response to the data read request further comprising a predicate, and the predicate being a conditional expression of the third object column, when the predicate is applied to the inverted index, determining a line number in an inverted chain that satisfies the predicate and a line number in the missing value inverted chain as candidate line numbers.

17. The data processing device according to claim 10, wherein the method further comprises:
in response to the data read request further comprising a predicate, and the predicate being a conditional expression of a fourth object column, establishing, based on a bitmap corresponding to the fourth object column and actual data comprised in the fourth object column, a memory structure of the fourth object column;
determining a target line number in which the actual data comprised in a target data column satisfies the predicate, and determining a line number in which a target loss identification column has data loss as a target line number that satisfies the predicate, wherein the target data column is a data column in the memory structure of the fourth object column, and the target loss identification column is a loss identification column in the memory structure of the fourth object column; and
obtaining, from the memory structure of the column, data of the data column of the column in the target line number.

18. The data processing device according to claim 10, wherein the method further comprises:
in response to the data read request further comprising a predicate, and the predicate being a conditional expression of a fourth object column, establishing, based on a bitmap corresponding to the fourth object column and actual data comprised in the fourth object column, a memory structure of the fourth object column;
writing a default value into a target data column for a line in which a target loss identification column has data loss, wherein the target data column is a data column in the memory structure of the fourth object column, and the target loss identification column is a loss identification column in the memory structure of the fourth object column;
determining a target line number in which the actual data comprised in the target data column satisfies the predicate, and determining a line number in which the target data column has the default value as a target line number that satisfies the predicate;
modifying the default value in the target data column to data loss; and
obtaining, from the memory structure of the column, data of the data column of the column in the target line number.

19. A non-transitory computer-readable storage medium, wherein the computer-readable storage medium stores instructions, and the instructions, when being run on a terminal device, cause the terminal device to perform a data processing method based on a columnar storage database comprising:
storing, for a target column in a data table, a line loss identification of the target column by using a bitmap corresponding to the target column, wherein each bit of the bitmap corresponds to whether each line of the target column has data loss, and the target column is any column in the data table;
storing actual data comprised in the target column;
receiving a data read request, wherein the data read request comprises a column; and
establishing, in a memory, a memory structure of the column based on a bitmap corresponding to the column and actual data comprised in the column, wherein the memory structure comprises a loss identification column and a data column, the loss identification column and the data column each comprise the same number of lines, each line of the loss identification column corresponds to each bit of the bitmap of a corresponding column, and the data column has the actual data comprised in the corresponding column in a line in which a corresponding line of the loss identification column has no data loss.

20. The non-transitory computer-readable storage medium according to claim 19, wherein the method further comprises:
reading a maximum-minimum index of a first object column in the data table;
reading a first line number range in a bitmap corresponding to the first object column, wherein the first line number range is a line number range corresponding to the maximum-minimum index; and
in response to data loss existing in the first line number range, marking the maximum-minimum index as invalid, such that the first line number range in the data table is not filtered when the maximum-minimum index is applied.
